(19) United States
(12) Patent Application Publication
(10) Pub. No.: US 2018/0239874 A1
(43) Pub. Date: Aug. 23, 2018

(54) DYNAMIC INTERVENTION FOR INDIVIDUALS BASED ON DETECTED CONTEXTUAL FACTORS

(71) Applicant: Welltok, Inc., Denver, CO (US)

(72) Inventors: Paul Ingram, Poulsbo, WA (US); Benjamin Edick, Seattle, WA (US); Elizabeth Quinn, Seattle, WA (US)

(21) Appl. No.: 15/438,446

(22) Filed: Feb. 21, 2017

(51) Int. Cl. G06F 19/00

(52) U.S. Cl. CPC G06F 19/3431; G06F 19/3437; G06F 19/3418

(57) ABSTRACT

A wellness intervention system that collects data about multiple factors pertaining to an individual's health and uses such data to generate timely and targeted interventions due to anticipated changes in the wellness of the individual. Collected factor data that directly characterizes the health of individuals is used to generate wellness scores characterizing the individual over time. The generated wellness scores are evaluated against contextual factors from the collected data to identify the contextual factors that, for the particular individual, are correlated to changes in individual wellness. The identified contextual factors and correlations form the individual's correlation trigger matrix. By periodically monitoring the individual and comparing recently-observed contextual factors of the individual against the individual's trigger matrix, the system may identify when the individual's behaviors (as reflected in the contextual factors) are indicative of individual wellness changes, and may generate targeted interventions for the individual, including recommendations and warnings, accordingly.

### BACKGROUND

Certain factors are known to directly reflect the overall well-being (or “wellness”) of an individual. For example, the blood pressure of an individual, the individual's cholesterol level, and the amount of sleep he or she gets on a nightly basis may all be indicative of the individual's physical well-being. In a similar fashion, an individual's self-assessment (e.g., “I feel happy” or “I feel sad”) is generally illustrative of the individual's mental well-being. In an ideal environment, these direct factors would be monitored on a continuous basis and could be used to identify when an individual's well-being is in decline. Typically, however, it is infeasible to achieve monitoring of these direct factors with the frequency needed to support such well-being alerts. For example, cholesterol levels and other similar factors may only be evaluated annually during a physical, and an individual may only be willing to answer questions regarding his or her mental state every few weeks.

Perhaps more importantly, however, the wellness of an individual is also impacted by various contextual factors. For example, the well-being of some individuals is impacted by temperature (hot or cold), while others are impacted by the stress of travel. Because each individual is impacted differently by environmental factors, however, there has been very little effort to measure the impact of contextual factors on individual individuals. Moreover, there has been no ability to control for the potential wellness impact of these factors. It would therefore be desirable to be able to identify the contextual factors that correlate with positive and negative changes in well-being on an individualized level, thereby facilitating individualized wellness monitoring and intervention based on dynamic contextual factors.

### BRIEF DESCRIPTION OF THE DRAWINGS

FIG. 1 is diagrammatic overview of the steps performed by the wellness intervention system to identify factors impacting the wellness of the individual and intervene accordingly.

FIG. 2 is a table containing representative objective and subjective data monitored by the system about the wellness of the individual.

FIG. 3 is a diagram of a representative environment in which a wellness intervention system operates to identify factors that impact the wellness of an individual.

FIG. 4 is flow chart of a process implemented by the wellness intervention system to calculate scores characterizing different wellness aspects of the individual.

FIG. 5 is a flow chart of a process implemented by the wellness intervention system for generating a trigger matrix for the individual based on identified factors that positively and negatively impact the wellness of the individual.

FIG. 6 is a representative example of a trigger matrix that is generated by the system for the individual.

FIG. 7 is a flow chart of a process implemented by the wellness intervention system to monitor factors associated with an individual and predict trends in the individual's wellness that may necessitate an intervention.

FIG. 8 is a graph of the individual's wellness over time, with points of intervention identified by the system.

The techniques introduced in this disclosure can be better understood by referring to the following Detailed Description in conjunction with the accompanying drawings.

### DETAILED DESCRIPTION

A wellness intervention system that collects data about multiple factors related to the wellness of an individual, and triggers targeted interventions of the individual based on trends identified in the multiple factors, is disclosed herein. The system collects data directly characterizing the wellness of an individual as well as contextual data pertaining to factors that might have an impact on the wellness of the individual. Using the data that directly characterizes wellness, the system calculates scores that characterize the current wellness of the individual. Such wellness scores may characterize the overall wellness of the individual (e.g., on a spectrum from very health to very unhealthy), or may characterize different wellness aspects of the individual (e.g., dietary wellness, fitness wellness, disease risk wellness, etc.), at that point in time. By periodically determining wellness scores based on recently monitored direct factors, the system also constructs a time series of the individual's wellness scores. The system evaluates the time series of the individual's wellness scores against changes over time in the individual's contextual factors, and based on the evaluation, identifies the contextual factors that are correlated with improvements or declines in the individual's wellness scores. The identified contextual factors, as well as which wellness aspects they impact, are maintained in a “trigger matrix” for the individual. At any point in time, the trigger matrix reflects those combinations of contextual factors likely to produce an improvement or decline in the individual's wellness.

Once a trigger matrix has been constructed for an individual, the system continues to monitor the individual and, based on comparisons between the monitored contextual factors and the individual's trigger matrix, identifies instances that indicate a likely change in the individual's wellness. When detrimental wellness changes are likely to occur the system triggers a targeted intervention of the individual, such as a message encouraging an occurring wellness improvement, or recommended changes to reverse a wellness decline. When positive wellness changes are likely to occur, the system may trigger a targeted intervention which encourages the individual to continue their course of action.

Certain data collected by the system relate to factors that directly characterize the current or past wellness of an individual. For example, the collected data may be objective measures of the individual's heart rate, blood pressure, blood sugar level, length of sleep, etc. Collected factors directly relating to the wellness of the individual may further include information regarding any chronic medical conditions of the individual (e.g., arthritis, asthma, cancer, etc.), acute injuries suffered by the individual (e.g., broken leg, concussion, torn ligament, etc.), or medically relevant events (e.g., information related to a car accident, slip and fall, etc.). Collected factors directly relating to the wellness of the individual may additionally include subjective data about the wellness of the individual that is received directly from the individual. For example, the individual may periodically be presented with a series of questions which solicit the individual's perceptions of the individual's wellness state. In addition to the different types of direct data, the system also collects data related to contextual factors that impact or characterize the wellness of the individual. For example, the collected data may include objective information about environmental factors around the individual, such as the weather around the individual, location of the individual, news events that may impact individual, etc. Other collected data may be subjective data which may characterize the individual's state, such as information solicited from a spouse or significant other of the individual or information gleaned from social networks of the individual. Data about the different types of factors monitored by the system, whether objective or subjective, direct or contextual, are monitored and captured by the system over time.

The wellness intervention system utilizes one or more wellness assessment models to characterize the wellness of an individual based on the individual's monitored direct factors. The different models may characterize different aspects of the individual's wellness (e.g., dietary wellness, physical fitness wellness, etc.), as well as overall wellness. To develop the models, a population of individuals having monitored direct factors is manually assessed to qualitatively and quantitatively characterize wellness aspects of the corresponding individuals. The qualitative and quantitative characterization may be based on, for example, medical models that reflect how the observed direct factors reflect the different aspects of an individual's wellness. The set consisting of individual direct factors and corresponding assigned wellness scores is used by the system to train the wellness assessment models using, for example, machine learning techniques. Once trained, the wellness assessment models can be applied by the system against the direct factors of any individual to derive wellness scores for the individual associated with the different wellness aspects.

As direct data is gathered over time by the system about a particular individual, the system periodically updates the individual's wellness scores. To do so, the system applies the wellness assessment models to determine the current wellness scores, associated with overall wellness as well as wellness aspects, of the individual. The system may update wellness scores upon the detection of certain events, such as the individual's completion of a survey, achieving of a fitness goal, participation in a rewards program, etc. The wellness score updates may also occur periodically as determined by the system, such as daily, weekly, opportunistically based on the amount of new direct data observed by the system, etc. The system stores the wellness scores of the individual each time they are calculated, and associates the scores with time stamps, or temporal markers, indicating the event or time with which each update is associated. The wellness scores and corresponding time stamps will be referred to herein as the individual's “wellness scores time series.” It will be appreciated that an individual will likely have periods and discrete events in their life when they experience improvements or declines in wellness. The wellness scores time series reflects such changes over time for the individual. As described herein, the system uses the wellness scores time series to identify relevant contextual factors that the system utilizes to facilitate timely interventions of the individual.

In addition to monitoring direct factors, the system also monitors and stores data characterizing the various contextual factors impacting the individual. The contextual factors may be captured and stored by the system on a more frequent basis than the direct factors, such as hourly, daily, or weekly. For example, throughout the day the system may determine and store the individual's current location, the weather at the current location, the recency of the individual's last social media activity, etc. The monitored contextual factors may be associated with time stamps corresponding to when the monitoring occurred, from which the system can generate a time series of contextual factors for the individual. Monitored contextual data may be pre-processed before being included in the individual's contextual factor time series. For example, contextual factor data may be quantized by the system based on the expected range for each factor before being stored in a time series. As a further example, contextual factor data may be normalized so that different factors can be compared against one another.

Based on the time series of contextual factors and time series of wellness scores associated with an individual, the system identifies which contextual factors cause positive or negative changes in the individual's wellness. The identified contextual factors provide the basis on which the system will trigger interventions for the individual. The system may identify isolated factors associated with wellness changes, as well as multiple factors that, when simultaneously present or observed in a particular sequence, are associated with wellness changes. The system may also determine the strength of correlation between contextual factor changes and wellness changes. Different contextual factors may be differently weighted for different wellness scores associated with different wellness aspects. That is, for an individual the system may identify that a particular set of contextual factors has a strong relationship to that individual's dietary wellness, but those same contextual factors have no relationship to that individual's susceptibility to disease. The identification of contextual factors for an individual, including which wellness aspect changes are correlated to the factors and how strongly, can be performed using a machine learning algorithm. Based on the identified contextual factors, the system generates a trigger matrix for the individual. The trigger matrix represents, for that individual, the ways in which different individual or combinations of contextual factors influence different wellness aspects of the individual.

The system can provide, on an as-needed basis, interventions of an individual when that individual is susceptible to positive or negative wellness changes. To do so, the system continues to monitor various contextual factors associated with the individual. When the system detects the presence of a combination of monitored factors having an impact on one or more aspects of the individual's wellness, based on an evaluation of the individual's trigger matrix and the state of the individual's contextual factors, the system may elect to trigger an intervention action. Intervention actions include, but not are limited to, email encouragements, financial incentives, text alerts, contacting personal coaches, triggered warnings to trained medical personnel, or other notifications to the individual or parties concerned about the wellness of the individual. Interventions may be triggered in response to anticipated positive wellness changes (e.g., a note of encouragement) or anticipated negative wellness changes (e.g., a notification that the individual should cease an activity correlated with declining wellness).

On a periodic basis, the system may re-generate the trigger matrix of the individual based on additional data characterizing the individual. For example, the trigger matrix may be updated by the system when the system receives an updated contextual factor time series and wellness scores time series for the individual. The updated trigger matrix may be used to refine which events, as reflected in the contextual factors, trigger interventions of the individual. In doing so, the system is able to identify changes to the contextual factors which impact the individual's wellness over time.

The system may also, on a periodic basis, update the wellness assessment models based on additional data characterizing the wellness changes of individuals within the population. For example, the system may receive updated indications of overall wellness of monitored individuals from medical professionals, dieticians, personal trainers, etc. The updated wellness information may be used by the system to refine the wellness assessment models which assess the wellness aspects of individuals within the population based on their corresponding direct factors.

Various implementations of the system will now be described. The following description provides specific details for a thorough understanding and an enabling description of these implementations. One skilled in the art will understand, however, that the system may be practiced without many of these details. Additionally, some well-known structures or functions may not be shown or described in detail so as to avoid unnecessarily obscuring the relevant description of the various implementations. The terminology used in the description presented below is intended to be interpreted in its broadest reasonable manner, even though it is being used in conjunction with a detailed description of certain specific implementations of the system.

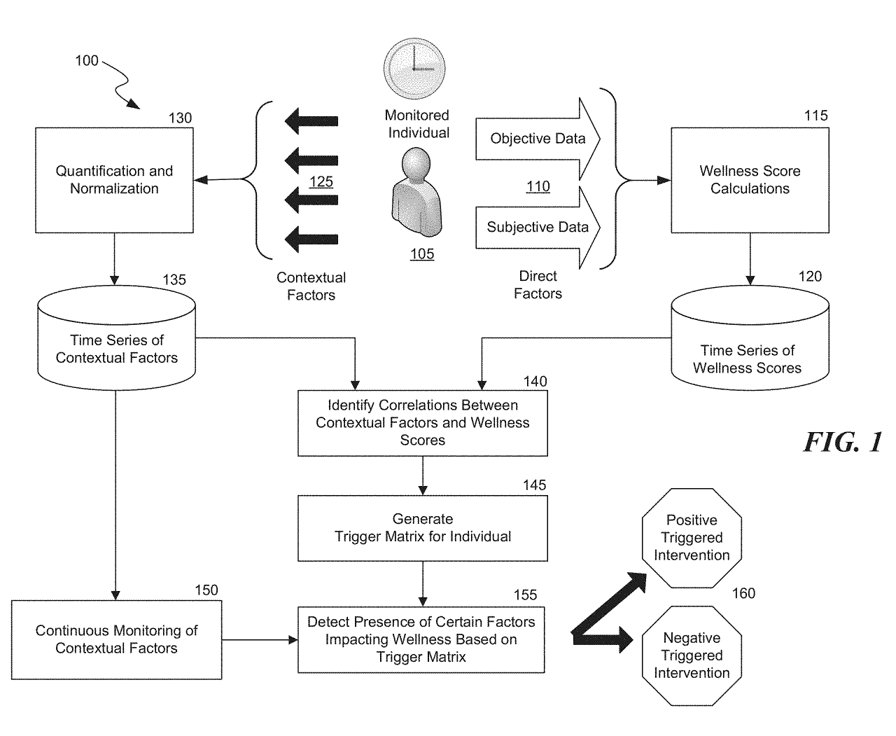

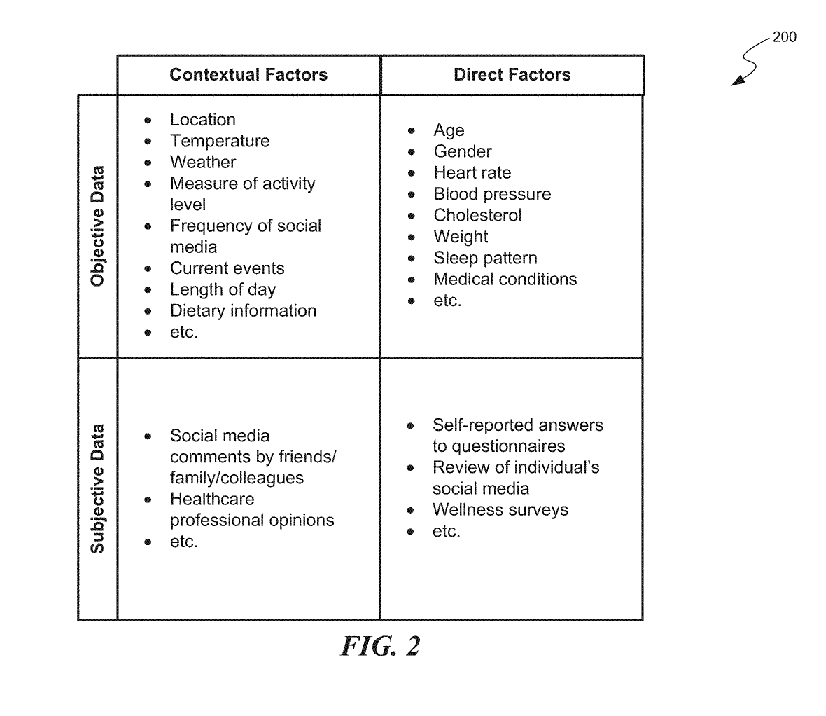

FIG. 1 and the following discussion provide a brief, general description of a diagrammatic overview of steps 100 performed by a wellness intervention system. FIG. 1 illustrates steps performed by the wellness intervention system for triggering positive or negative wellness interventions 160 for a monitored individual 105. The individual may be monitored on a periodic or continuous basis. Monitored data of the individual includes direct factors 110 and contextual factors 125. Direct factors directly characterize the wellness of the individual, and may include objective measures such as the individual's heart rate, blood pressure, age, weight, cholesterol level, length of sleep, medical conditions, acute injuries, etc. Contextual factors relate to other factors that impact or characterize the wellness of the individual, such the weather at the individual's location, the amount of business or recreational travel done by the individual, the frequency of social activities undertaken by the individual, etc. An illustration of representative factor data that may be monitored by the system is illustrated in FIG. 2, described below.

FIG. 2 is a table 200 that illustrates different categories of factors that may be monitored and utilized by the system. As illustrated, factors may be categorized as either contextual factors or direct factors. Direct factors directly characterize the wellness of the individual, and may be used by the system to generate individual wellness scores. Contextual factors reflect other factors that may impact or characterize wellness, depending on the individual, and as described herein may be used by the system to identify opportunities for targeted intervention of the individual. As further illustrated, both direct and contextual factors may be further categorized as either objective or subjective. Objective factors represent factors that may be directly observed or measured. In contrast, subjective factors represent factors that involve a qualitative or other subjective assessment. For example, an individual's cholesterol level is an objective factor directly bearing on the individual's health, while a health survey completed by the individual is a subjective factor directly bearing on the individual's health. As a further example, the occurrence of certain current events is an objective contextual factor that may be relevant to an individual's wellness, while social media comments made about the individual by the individual's social media network is a subjective contextual factor that may be relevant to the individual's wellness.

The data about an individual may be gathered by the system using a variety of techniques. Monitoring may be achieved, for example, using sensors connected to or adjacent to the individual. For example, the individual may wear a fitness band or smart watch which gathers information about the heart rate of an individual. As another example, the individual may carry a smartphone which monitors movement of the individual. From the movement information, the smartphone is able to estimate the number of steps that an individual takes during a particular period. By monitoring sensor data associated with the individual, the system is able to obtain information about the current physical condition of the individual. Other data may be gathered by the system by accessing various data sources. One example of a data source containing information relevant to an individual's health state is the stored health information about an individual. With authorization, the system may access an individual's stored medical information in order to identify certain medical conditions afflicting the individual. Another example of a data source that can be consulted by the system is a weather service. Using a known location of an individual, the system may use an application programming interface (API) to access a service and receive information about the current or anticipated weather at the location of the individual. A further example of a data source that can be consulted by the system is the online activities of the individual. For example, the individual may grant the system access to the individual's social networks, e-mail accounts, browsing activities, etc. By accessing the individual's online activities, the system may be able to monitor, for example, the frequency of the individual's social network activity, the recipients of e-mail messages sent by the individual, and the topics of web sites visited by the individual. Finally, the system may gather information about the individual through questions or surveys that are presented either directly to the individual or to others that know the individual. The questions or surveys can be used by the system to directly solicit information which may relate to the current health state of the individual.

Referring again to FIG. 1, the individual's monitored direct factors are evaluated by the system to calculate wellness scores 115. Each of the calculated wellness scores may be calculated based on a different wellness assessment model, where each wellness model characterizes an individual's overall wellness or one of several wellness aspects. For example, a first wellness assessment model may generate a wellness score associated with dietary wellness, a second wellness assessment model may generate a wellness score associated with susceptibility to disease, a third wellness assessment model may generate a wellness score associated with mental wellness, a fourth wellness assessment model may generate a wellness score associated with overall wellness, etc. That is, each of the calculated wellness scores is associated with a different aspect of the individual's wellness. After a wellness score is calculated, the system associates each wellness score with a timestamp or other temporal marker corresponding to the time at which the direct factors (on which the wellness score is calculated) are observed. The wellness scores for a particular aspect and associated timestamps form a time series for that aspect, and the collection of per-aspect times series combine to form a time series of wellness scores 120 for the individual. In other words, the system continually or periodically calculates wellness scores for an individual based on the direct factors monitored at that time. The wellness scores are then maintained in a time series for the individual, thereby capturing the changes in the individual's wellness over time across different wellness aspects.

In addition to evaluating the direct factors as described above, the individual's contextual factors are also processed by the system. For example, each of the contextual factors may be quantized and normalized 130. Quantizing a factor derives a value for that factor based on the expected factor ranges. Normalizing a factor enables the comparing of the factor with other factors. Each contextual factor, which may be quantized, normalized, or otherwise processed, is associated with a timestamp for when the contextual factor was monitored, which forms a per-factor time series. The collection of per-factor time series is combined to form a time series of contextual factors 135 associated with the individual.

On a continuous or periodic basis, the time series of contextual factors 135 and time series of wellness scores 120 are evaluated to identify correlations 140 between contextual factors and wellness scores. The identified contextual factors are those factors that, in isolation, in combination, in sequence, or any combination of the above, have been determined by the system as influencing the wellness of the individual. That is, changes in the identified contextual factors are, for the particular monitored individual, correlated to changes in one or more wellness aspects. Correlations may be identified, for example, by time-aligning the contextual factor and wellness scores times series of the monitored individual, and identifying any patterns in which changes in contextual factors are followed by changes in wellness scores. Such identifications may be performed, for example, using machine learning analysis. It will be appreciated that different groups of contextual factors may be correlated to changes in the same wellness aspect, and that a group of contextual factors that are correlated to one wellness aspect may not be correlated to a different wellness aspect. Furthermore, each of the correlations may be associated with a weight, reflecting the strength of correlation, as determined by the system. The identification of correlated contextual factors may be performed upon the occurrence of certain events (for example, when the individual's wellness scores have been updated, when new factors have been observed from the individual, etc.) or when a threshold amount of time has occurred since the previous identification.

Once the contextual factors that correlate to one or more wellness aspects for the individual have been identified, the system generates 145 a trigger matrix for the individual. The trigger matrix encodes the identified correlations between contextual factors and wellness aspects for an individual, referred to herein as “influence correlations.” In other words, the trigger matrix represents, for the individual, which changes in contextual factors are likely to lead to positive or negative changes in the individual's wellness as embodied by the individual's set of influence correlations. Contextual factors recited in the trigger matrix may be in isolation (e.g., “spent at least 45 minutes in the sun”), in combination (e.g., “spent at least 45 minutes in the sun and went for a 30 minute jog”), and in sequence (e.g., “spent at least 45 minutes in the sun and then went for a 30 minute jog”). The contextual factors may be correlated to different wellness aspects, may exhibit a positive, negative, or neutral correlation type (e.g., correlated to positive or negative changes in the associated wellness aspect), and be associated with different correlation weights. In some embodiments the trigger matrix encompasses all of the correlated contextual factors identified by the system. In some embodiments the trigger matrix only includes those factors meeting a threshold strength of correlation (i.e., exceed a certain correlation weight).

On an ongoing basis, the system continues to monitor 150 the contextual factors associated with the individual. It will be appreciated that contextual factors can often be monitored at a greater frequency than direct factors. For example, the system can monitor the location associated with the individual on a nearly real-time basis, based on location data obtained a mobile device associated with the individual. The system can additionally obtain weather data associated with the monitored location. As a further example, the system can continuously monitor social media activity associated with the individual. It will be appreciated that, as described herein, because the contextual factors correlated to wellness changes may be monitored on a more frequent basis, the system can be more responsive to relevant wellness-influencing events as they occur.

Using the continuously monitored contextual factors, the system identifies 155 whether among the monitored factors there is a combination of factors that impact the wellness of the individual. In other words, the system determines whether the contemporaneous or recent contextual data indicates that the individual is likely to experience a positive or negative wellness change. The determination is made using the trigger matrix associated with the individual. For example, the system may compare the recent contextual factor data of the individual with the individual's trigger matrix, and identify whether any of the influence correlations encompassed in the matrix are satisfied by the monitored factor data. If one or more influence correlations are satisfied by the individual's recent contextual data, the system triggers positive or negative interventions 160. Interventions may be based on the type of imminent or likely to occur wellness changes identified by the system. For example, if the system identifies the occurrence of certain contextual factors that are likely to lead to positive wellness change, the system may send a note of encouragement to the individual encouraging them to continue the corresponding activities. As a further example, if the system identifies that the occurrence of certain contextual factors likely to lead to a negative wellness change, the system may send a message warning the individual of a potential wellness decline and highlight certain current behaviors of the individual that could be altered to avoid the decline. The steps 100 may repeat, to provide ongoing monitoring and intervention of the individual.

### Suitable Environments

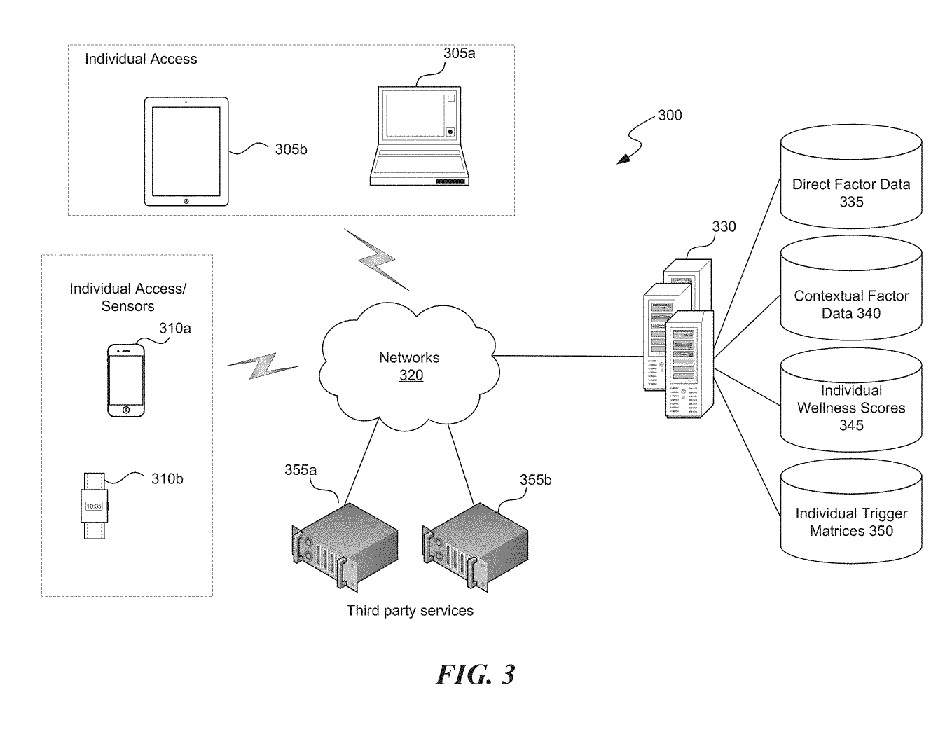

FIG. 3 and the following discussion provide a brief, general description of a suitable environment in which a system that provides dynamic wellness interventions of individuals based on contextual factors may be implemented. Although not required, aspects of the system are described in the general context of computer-executable instructions, such as routines executed by a general-purpose computer, a personal computer, a server, or other computing system. The system can also be embodied in a special purpose computer or data processor that is specifically programmed, configured, or constructed to perform one or more of the computer-executable instructions explained in detail herein. Indeed, the term “computer” and “computing device,” as used generally herein, refer to devices that have a processor and non-transitory memory, like any of the above devices, as well as any data processor or any device capable of communicating with a network. Data processors include programmable general-purpose or special-purpose microprocessors, programmable controllers, application-specific integrated circuits (ASICs), programming logic devices (PLDs), or the like, or a combination of such devices. Computer-executable instructions may be stored in memory, such as random access memory (RAM), read-only memory (ROM), flash memory, or the like, or a combination of such components. Computer-executable instructions may also be stored in one or more storage devices, such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

Aspects of the system can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Aspects of the system described herein may be stored or distributed on tangible, non-transitory computer-readable media, including magnetic and optically readable and removable computer discs, stored in firmware in chips (e.g., EEPROM chips). Alternatively, aspects of the system may be distributed electronically over the Internet or over other networks (including wireless networks). Those skilled in the relevant art will recognize that portions of the system may reside on a server computer, while corresponding portions reside on a client computer.

FIG. 3 illustrates an example environment 300 in which a dynamic individualized wellness intervention system operates. The environment may include one or more client computing devices 305, wellness sensors 310, server computers 330, and third party services 355. Wellness sensors 310 may be used to monitor wellness factors of an individual, and are typically on or adjacent to the monitored individual. For example, sensor 310a illustrates a smartphone which may be used to track the location and movement of the individual. As a further example, sensor 310b illustrates a smart watch which may be used to monitor the heart rate of the individual. The client computing devices 305 and sensors 310 communicate with each other and the server computers 330 and third party services 355 through networks 320 including, for example, the Internet. The client computing devices 305 and sensors 310 may communicate wirelessly with a base station or access point using a wireless mobile telephone standard, such as the Global System for Mobile Communication (GSM), or another wireless standard, such as 802.11 (WiFi) or Bluetooth, and the base station or access point communications with server computers 130 and third party services 355 via the network 320.

Aspects of the dynamic individualized wellness intervention system may be practiced by the client computing devices 305, wellness sensors 310, server computers 330, and third party services 355. For example, direct factors characterizing the wellness of an individual may be received by the server computers 330 from a client computing device 305 and a sensor 310 associated with the individual, as well as third party services 355. That is, the server computers 330 may receive an individual's heart rate from sensor 310b and an individual's response to a survey directed to mental well-being from client computing device 305. The server computers 330 may also receive social media content authored by the individual from third party services 355. Direct factor data may be received by the server computers 330 on a periodic basis (e.g., weekly, monthly, annually, etc.), and is stored in direct data storage area 335. As a further example, contextual factors characterizing the wellness of the individual may be received by the server computers 330 from client computing devices 305, sensors 310, and third party services 355. Contextual factors may include data from individuals other than the individual. For example, the servers 330 may receive survey responses, provided by a spouse of the individual and pertaining to the mental state of the individual, from a client computing device 305 associated with the spouse. The server computers 330 may also receive environmental data from third party services 355, such as the weather and temperature at the individual's current location. Contextual factor data may be received by the server computers 330 on a periodic basis (e.g., hourly, daily, weekly, etc.), and is stored in contextual data storage area 340.

On a periodic or ongoing basis, the server computers 330 calculate and maintain a set of wellness scores for the individual based on the stored direct factor data. An individual's wellness scores may be based on wellness assessment models, maintained by the system, that derive a wellness assessment for different wellness aspects based on direct factors. The individual's wellness scores may change over time based on changes to the direct factors associated with the individual, changes to the wellness assessment model, etc. The time series of wellness scores for the individual are stored in wellness scores storage area 345.

When the system has a sufficient number of wellness scores and contextual data for an individual over an adequate timeframe, the server computers 330 identify which combinations of one of more contextual factors correlate to positive or negative changes in the wellness scores of the individual. For example, the system may determine that a particular combination of contextual factors positively influences the wellness of the individual, while a different combination of contextual factors negatively influences the wellness of the individual. Identification of the combination of contextual factors and their influences may be achieved, for example, using machine learning techniques that identify patterns of changes in contextual factors that occur shortly before changes in wellness scores. Based on the total set of influences (e.g., a combination of contextual factors, whether the combination is correlated with positive or negative changes in wellness scores, and the extent of the influences), the server computers 330 generate a trigger matrix for the individual. The trigger matrix encompasses the set of wellness triggers that have been determined to influence the individual's wellness. The individual's trigger matrix is stored in trigger matrix storage area 350. It will be appreciated that different amounts of wellness scores and contextual data may be required before the system can adequately identify correlations for an individual. In some embodiments the system detects when it has observed enough data for an individual to provide adequate analysis. For example, the system might require one week, several weeks, or a month of data before attempting to identify correlations for an individual. In some embodiments the system may be configured to require a certain amount of data (e.g., a certain number of wellness score and contextual data observed over time) before identifying correlations for an individual.

Identifying Contextual Factors Correlated with Individual Wellness

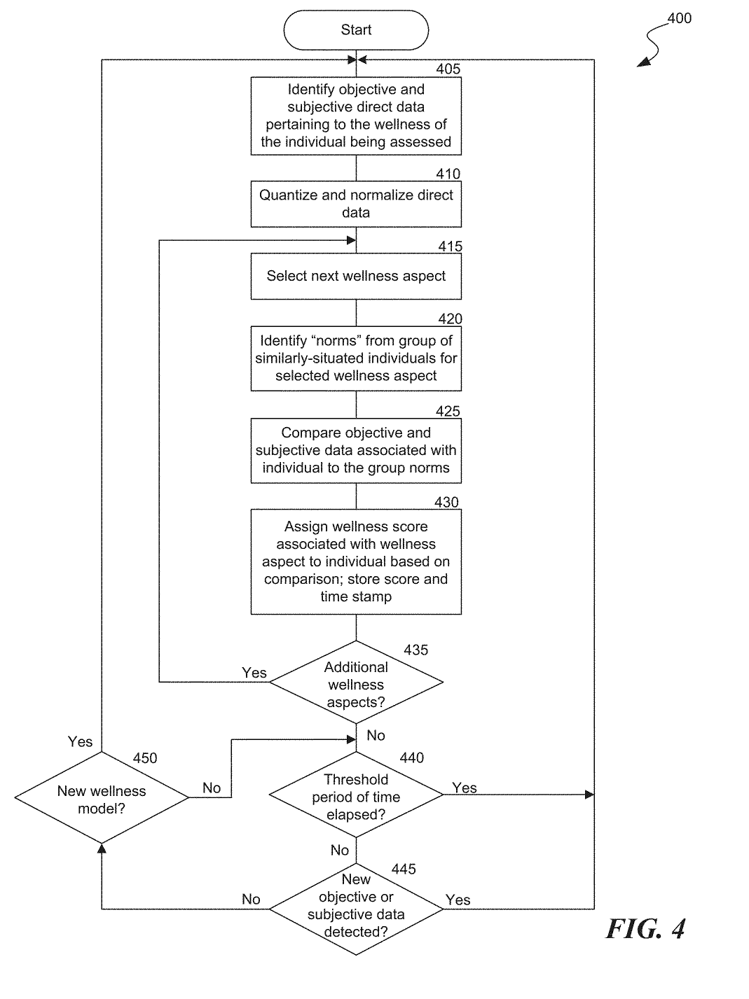

FIG. 4 is a flow diagram illustrating an example process 400, implemented by the wellness intervention system, for calculating wellness scores characterizing different wellness aspects for an individual. As described herein, the calculated wellness scores facilitate the subsequent identification of contextual factors that, for the individual, are correlated to wellness changes.

The process 400 begins at a block 405, where the system identifies direct factor data for the individual for whom wellness scores are being generated. The direct factor data may, for example, be data that has been contemporaneously or recently monitored from the individual. The direct factor data may, as an additional example, have been monitored by the system and stored in a data storage area of monitored factors, from which the direct factors are retrieved by the system.

At a block 410, the system quantizes and normalizes the direct factor data. For example, the system may quantize the direct factor data based on expected ranges for each factor. Additionally, the system may normalize the direct factor data so that different direct factors may be compared.

At a block 415 the system selects the next wellness aspect for which an associated wellness score is to be generated. As described herein, each individual's wellness may be characterized by a number of different wellness aspects. For example, an individual's wellness may be characterized in terms of their dietary wellness (i.e., the healthiness of their eating habits), their disease wellness (i.e., their susceptibility to catching diseases such as the common cold), their fitness wellness (i.e., how in-shape they are). The individual may also be characterized by an overall wellness that represents overall health. As described, the system generates wellness scores for each of multiple wellness aspects. At block 415, the wellness aspect to be next analyzed by the system is therefore selected.

At a block 420 the system identifies the expected direct factor data values, or “norms,” for population members who have a positive qualitative assessment with respect to the selected characteristic (e.g., known to have healthy eating habits, known to be overall healthy, etc.). For example, norms may have been manually derived by health professional based on their assessments of individuals within a population. As a further example, norms may been derived based on machine learning techniques used to analyze a set of known-well individuals (such as those assessed as such by a health professional) and identify direct factors that correlate with positive qualitative health assessments. Though in the example process 400 the identification of norms is illustrated as occurring as part of the process for generating wellness scores for an individual, in other embodiments the norms may have been previously generated by the system, and the norms for each wellness aspect retrieved by the system as a part of the operation of block 420. For example, the direct factor data may be retrieved from direct factor data storage area 335.

At a block 425 the system compares the identified direct factor data of the individual, both objective and subjective, against the identified norms for the selected wellness aspect. The system evaluates the differences between the individual's direct factors and known norms and, based on that evaluation, generates a wellness score characterizing the individual's wellness with respect to the associated wellness aspect. The wellness score may be generated, for example, by applying a wellness assessment model, which comprehends the desired direct factor norms for the associated wellness aspect, to the identified direct factors of the individual. The system may assign a numeric value to the wellness score within a closed range of values, e.g., a wellness score may range between 1-100. Alternatively or additionally, the wellness scores may be open-ended.

At a block 430 the system assigns the generated wellness score and an associated timestamp to the individual. As described herein, individual wellness scores may be associated with timestamps corresponding to the time at which the direct factors were monitored. Because a wellness score may be calculated a variable amount of time after the direct factor data is obtained, the system attempts to assign a timestamp that is associated with the time of direct factor data collection rather than the time at which the wellness score is calculated. Of course, in some circumstances the time of direct factor collection and calculation of wellness score may be in close proximity. By assigning the wellness score and timestamp to an individual, the system thereby generates a time series of wellness scores for the individual that tracks the individual's wellness changes over time. As described herein, however, the monitoring of certain direct factors may occur too infrequently (e.g., weekly, monthly, annually, etc.) to rely on the generated wellness score time series for facilitating timely wellness interventions. The generated wellness scores and time series of wellness scores may be maintained in individual wellness scores storage area 345.

At a decision block 435, the system determines whether there are any additional wellness aspects for which associated wellness scores are to be generated. As described, the system may comprehend different aspects of individuals' wellness, and may generate wellness scores for many or all of the aspects. If it is determined that that there are additional wellness aspects for which a wellness score is to be generated, then processing returns to the block 415 to select the next wellness aspect. If it is determined that there are no additional wellness aspects for wellness score generation, then processing continues to decision block 440.

At the decision block 440, the system determines whether a threshold period of time has elapsed since wellness scores were generated for the individual. The system may be configured, for example, to generate new wellness scores for an individual on a periodic basis to account for new wellness aspects comprehended by the system, new wellness norms identified by the same, new wellness assessment models maintained by the system, etc. For example, the system may be configured to generate wellness scores for the individual once a month, once every six months, once a year, etc. If it is determined that the threshold period of time has elapsed, processing returns to the block 405 to begin generating wellness scores for the individual. If it is determined that the threshold period of time has not elapsed, processing continues to a decision block 445.

At the decision block 445, the system determines whether any new direct factor data, either objective or subjective, is available for the individual. The system may be configured to generate new wellness scores for the individual based on newly available direct factor data. If it is determined that new direct factor data is available, processing returns to the block 405 to generate new wellness scores. If it determined that no new direct factor data is available, processing continues to a decision block 450.

At the decision block 450, the system determines whether any new or revised wellness models have been received. It will be appreciated that on a periodic basis the system may receive updated wellness assessment models for calculation of wellness scores, or the system may receive new wellness assessment models for the calculation of wellness scores for new wellness aspects. When it is determined that updated or new wellness assessment models have been received, processing returns to block 405 to begin generating new wellness scores for the individual. If it is determined that no new wellness assessment models have been received, processing returns to the decision block 440 so that the system may continue to evaluate whether any conditions (e.g., a threshold period of time has elapsed, new direct factor data becomes available, or new or updated wellness assessment models are available) have occurred that would trigger the generation of new wellness scores.

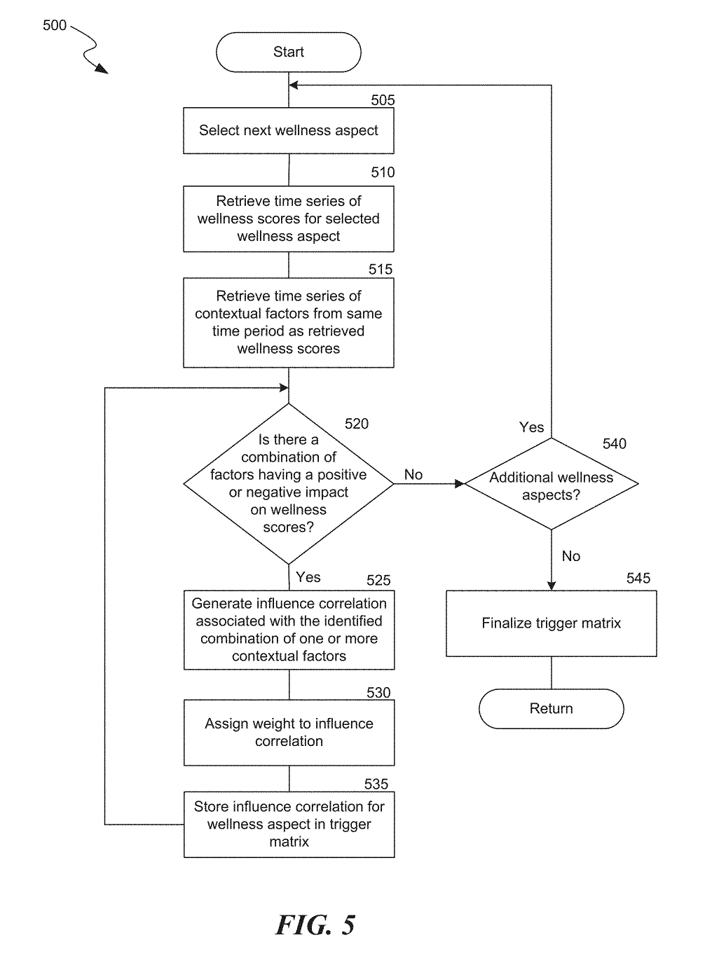

FIG. 5 is a flow diagram illustrating an example process 500, implemented by the wellness intervention system, for generating a trigger matrix for an individual based on identified contextual factors that positively or negatively impact the wellness of the individual. Broadly characterized, the process 500 identifies the different combinations of contextual factors correlated with changes in the different aspects of an individual's wellness, which combine to form the individual's overall trigger matrix. As described herein, the trigger matrix enables timely wellness interventions for the individual based on later detected events.

The process 500 begins at a block 505, where the system selects the next wellness aspect. As described herein, the system identifies correlations for each of the aspects that characterize the individual's wellness.

At a block 510 the system retrieves the individual's time series of wellness scores associated with the selected wellness aspect. The time series of wellness scores may be retrieved, for example, from individual wellness scores data storage area 345.

At a block 515 the system retrieves the time series of contextual factors for the individual. The time series of contextual factors may be retrieved, for example, from contextual factor data storage area 340. The system may retrieve contextual factors from the same or similar time period associated with the retrieved wellness scores. For example, if the system retrieved wellness scores for the past month then the system may retrieve contextual factors from the past month, or the system may retrieve contextual factors from the past 6 weeks.

At a decision block 520 the system determines if any contextual factors are identified as having a positive or negative impact on the wellness score for the selected wellness aspect. Contextual factors having an influence may be identified, for example, using pattern detection or machine learning techniques based on an analysis of time-aligned changes in wellness scores and contextual factors. For example, the system may monitor the individual's wellness score for the selected wellness aspect over time, and may identify when changes in the monitored wellness score occur. When wellness score changes occur, the system may evaluate the contextual factors for the individual and identify any contextual factors that change within a certain time period prior to the wellness score change. The system may only identify contextual factors based on the extent to which they change (e.g., which contextual factors change by at least a threshold amount just prior to the identified wellness score change), as well as the extent to which the wellness score subsequently changes. When the system determines that repeated patterns of contextual factors change, in multiple instances, during the evaluative time period prior to wellness score changes, that pattern of contextual factors may be identified as being correlated with wellness score changes. The system may determine that patterns of one or more contextual factors influence the wellness score of the individual. For example, the system may determine that changes in an individual factor influences changes in the wellness score. The system may determine that combinations of multiple factors influence wellness score changes (e.g., when a first factor is at a particular value and a second factor is at a particular value, then the wellness score changes). The system may also determine that sequences involving multiple factors influence wellness score changes (e.g., when a first factor has been at a value for a certain length of time and then a second factor changes values, then the wellness score changes). It will be appreciated that the system may identify impacts based on factor values (e.g., above or below a threshold value), factor changes (e.g., increasing, decreasing, staying the same), rate of factor changes (e.g., slope of change), etc. It will be appreciated that while many different combination of factors may influence a wellness score (e.g., a first factor and a second factor cause a wellness score to increase, and a third and a fourth factor also cause the wellness score to increase, where each pair is a distinct combination), the determination at decision block 520 may only identify a single combination. If it is determined that no combination of contextual factors influence the wellness score, then processing continues to a decision block 540. If it is determined that there is a combination of contextual factors that impact the wellness score, then processing continues to a block 525.

At the block 525 the system generates an influence correlation based on the identified contextual factors. The influence correlation is comprised of the set of factors identified in the particular combination and indicates what state or states the one or more factors need to cause the identified influence (e.g., a first factor needs to be above a certain value, a second factor needs to be declining, a third factor needs to be within a range, etc.).

At a block 530 the system assigns a weight to the generated influence correlation. The weight may be generated by the system based on, for example, a confidence level determined by the system that the combination of factors recited in the influence correlation will lead to the anticipated wellness change. For example, the system may have a 95% confidence that a first combination will lead to a wellness change and an 85% confidence that a second combination will lead to a wellness change, and weight the influence correlations corresponding to the first and second combination accordingly. As a further example, the influence correlations may be differently weighted depending on how drastic of a change in the wellness score has been observed. That is, influence correlations that are predicted to have a greater impact on wellness may be weighted more heavily.

At a block 535 the generated influence correlation and associated weight is saved to the trigger matrix of the individual. The process then returns to the decision block 520, so that the system may identify whether there are any additional combinations of factors (not yet represented by a generated influence correlation) that may be identified as having an impact on the wellness score for the currently selected wellness aspect.

If at the decision block 520 it was determined that there were no additional combinations of contextual factors impacting the wellness score associated with the selected wellness aspect, then at the decision block 540 the system determines whether there are any additional wellness aspects for which correlations are to be identified. If it is determined that there are additional wellness aspects, processing returns the block 505 to select the next wellness aspect. If it is determined that are no additional wellness aspects, processing continues to a block 545.

At the block 545 the system finalizes the trigger matrix for the individual. As described herein, the trigger matrix represents the influences of different wellness aspects for an individual, where each wellness aspect may be influences by different combinations of contextual factors represented by contextual influences. The system may maintain previously-generated wellness trigger matrices for the individual, and as part of the finalizing step the system may designate the most recently generated matrix as the individual's current matrix (based on which interventions will be triggered). As a further example the system may filter out influence correlations having an insufficient weight, indicating that the correlation has a small confidence of correlation or small influence impact, from the trigger matrix. As an additional example the system may limit the number of influence correlations included for each wellness impact. Once the trigger matrix is finalized, the process 500 returns.

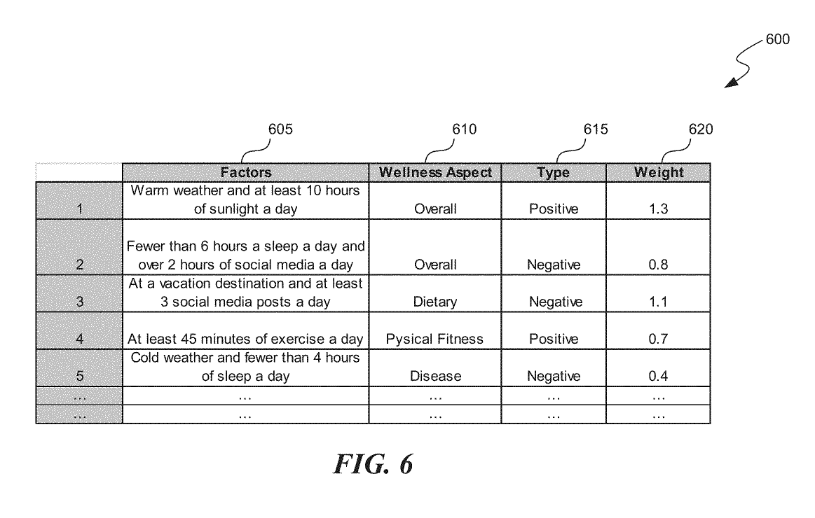

FIG. 6 illustrates a representative trigger matrix 600 generated for an individual. Each row of the matrix may represent an individual identified correlation, such as a correlation influence as generated by the process 500. The trigger matrix may include factor field 605, wellness aspect field 610, type field 615, and weight field 620. Factor field 605 indicates the one or more factors, as well as their value or state, associated with the corresponding wellness impact. For example, the factor field may indicate that a particular correlation influence is satisfied when a factor is at a certain value, when a combination of factors are at certain values, when a sequence of factors are increasing or decreasing, etc. Wellness aspect field 610 indicates which wellness aspect is influences by the correlation influence. For example, the wellness aspect field may indicate that overall wellness is impacted, that dietary wellness is impacted, etc. The wellness aspect field may additionally indicate that multiple wellness aspects are impacted by the correlation influence. Type field 615 indicates the type of impact of the correlation influence. For example, the field may indicate that a listed correlation as a positive or negative impact on the corresponding wellness aspect. Weight field 620 represents the weighting accorded to the influence correlation. For example, the weight may indicate the confidence in correlation between the listed factors and the wellness aspect, the magnitude of the impact triggered by the factors on the wellness aspect, a combination of confidence and extent of impact, or some other characterization of the significance of the given correlation influence on the wellness impact. Though illustrated as a human-readable table, it will be appreciated that other formats and machine-readable representations may be used for the trigger matrix.

### Providing Individualized Wellness Interventions

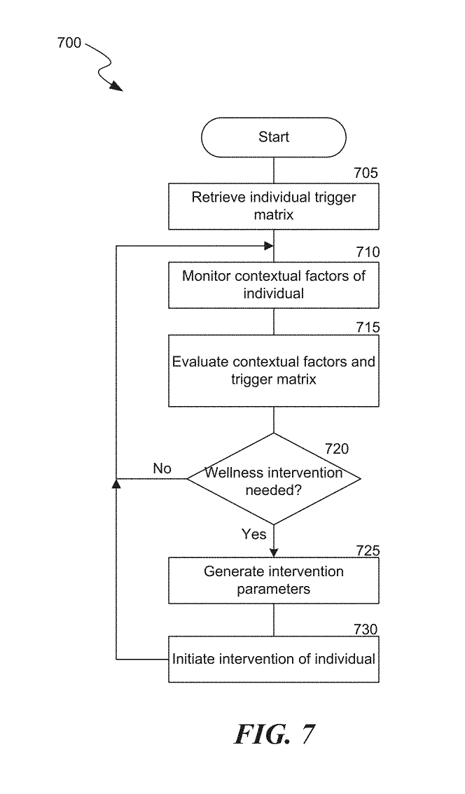

FIG. 7 is a flow diagram illustrating an example process 700, implemented by the wellness intervention system, for triggering wellness interventions for a monitored individual. The process 700 begins at a block 705, where the system retrieves the trigger matrix for the monitored individual.

At a block 710, the system monitors contextual factors associated with the individual. As described herein, contextual factors of the individual may be received from sensors associated with the individual, social media feeds associated with the individual, surveys completed by the individual or the individual's friends/family/co-workers/etc., wellness assessments generated by health professionals, etc. The system may receive data for the monitored contextual factors on a continuous or periodic basis.

At a block 715, the system evaluates the observed contextual factors and, based on the trigger matrix, identifies if the observed contextual state of the individual satisfies any of the correlation influences. For example, the system may compare the factor information for each correlation influence in the trigger matrix and determine whether the current or recent state of the individual's contextual factors match the factor description recited for that correlation influence. Those correlation influences for which there is a match would be identified as satisfied.

At a decision block 720 the system determines whether a wellness intervention is needed, based on the evaluation of the contextual factors of the individual and the individual's trigger matrix. The system may analyze the correlation influences identified by the block 715 to assess the need for a wellness intervention. The system may determine, for example, whether a sufficient number of correlation influences associated with a given wellness aspect have been identified. As a further example the system may determine whether the correlation influences identified for a wellness aspect collectively contribute a weight value sufficient to trigger an intervention. As an additional example the system may evaluate the number of identified correlation influences, regardless of whether the correlation influences are for the same or different wellness aspects. If the system determines that a wellness intervention is not needed, then processing returns to block 710 to continue monitoring the individual. If the system determines that a wellness intervention is needed, then processing continues to a block 725.

At the block 725 the system generates parameters for the needed intervention. The parameters for the intervention to be performed by the system may be influenced by the cause of the trigger for the intervention. For example, the context or delivery method of the intervention may be influenced by whether the intervention was triggered by an improvement or decline in wellness. As a further example, the context or delivery method of the intervention may be influenced by the wellness aspect corresponding to the intervention.

At a block 730 the system initiates the intervention of the individual. As described herein, the intervention may take one of a number of forms based on configuration of the system, the cause of the intervention, the individual for whom the intervention is targeted, etc. For example, the system may send a message to the individual directly. As a further example, the system may send a message to a health professional responsible for or associated with the individual. As an additional example, the system may send a message to a family member, friend, coworker or other person associated with the individual. The message may, for example, offer encouragement to continue a certain set of behaviors (corresponding to the identified contextual factors that have been identified as causing a wellness increase in the individual), warn to cease a certain set of behaviors (corresponding to the identified contextual factors that have been identified as causing a wellness decline in the individual), or recommend steps to mitigate potential detrimental health impacts from a certain set of behaviors (e.g., to get more sleep to counteract the detrimental impact of business travel). It will be appreciated that other forms of interventions may be utilized. Once the intervention has been initiated, the process returns to block 710 to continue monitoring the individual.

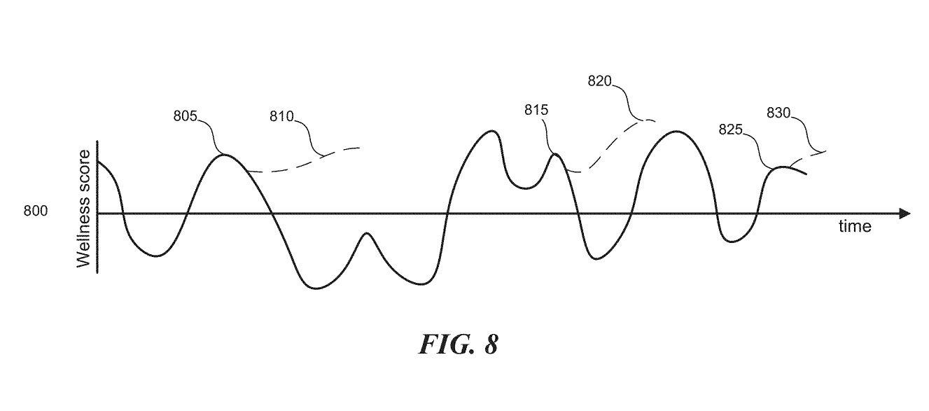

FIG. 8 illustrates a representative graph 800 of an individual's wellness over time, as well as indications of potential points of interventions identified by the system. As illustrated, the individual may generally experience periods of improving and declining wellness, and the system may intervene, for example, to aid the individual in avoiding wellness declines or to maintain periods of improved wellness. Though graph 800 illustrates wellness scores over time and potential interventions generated by the system, it will be understood that the graph 800 is for illustration purposes only. That is, as described throughout, the system uses monitored contextual factors (which have been identified as correlating with wellness changes for the individual) to determine when and how to trigger an intervention for the individual. Graph 800 therefore represents, for example, wellness changes predicted by the system (based on the monitored contextual factors), based on which interventions may be triggered. For example, the system may detect contextual factors consistent with wellness declines for the individual at time 805, and therefore trigger an intervention. The intervention may, for example, encourage the individual to cease or reduce the contextual factors known to cause declines in the individual's wellness. Intervention result 810 illustrates a potential outcome of the intervention, in which a predicted wellness decline was reversed and the individual's changed contextual factors are likely to lead to wellness improvements. As a further example, at time 815 the system may detect contextual factors consistent with a more dramatic decline in individual wellness. As a result the system may trigger a more dramatic intervention by, for example, encouraging a reversal of contextual factors consistent with wellness declines as well as encouraging additional of the contextual factors consistent with wellness improvements. Intervention result 820 illustrates a potential outcome of the intervention. As an additional example, at time 825 the system may detect that the individual's contextual factors are still consistent with wellness improvement, although at a reduced rate. The system may therefore trigger an intervention to try and maintain the previous levels of wellness improvement, as illustrated by intervention result 830. It will be appreciated that other events based on monitored contextual factors may be used by the system to generate an intervention. For example, the system may determine that the individual's contextual factors have been consistent with wellness improvements for a threshold duration, and may trigger an intervention to encourage the individual. It will be appreciated that while FIG. 8 illustrates a single wellness score curve 800, illustrative of predicted wellness score changes based on contextual factors, in some embodiments the system may predict changes to more than one wellness score for the individual (associated with, for example, overall wellness, dietary wellness, or other wellness aspects) from the monitored contextual factors, based on which wellness interventions may be triggered.

### CONCLUSION

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the disclosed technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative implementations may employ differing values or ranges.

These and other changes can be made to the disclosed technology in light of the above Detailed Description. While the above description describes certain examples of the disclosed technology, and describes the best mode contemplated, no matter how detailed the above appears in text, the disclosed technology can be practiced in many ways. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. In general, the terms used in the following claims should not be construed to limit the disclosed technology to the specific examples disclosed in the specification, unless the above Detailed Description section explicitly defines such terms.

I/We claim:

1. A computer-implemented method for monitoring an individual and generating a trigger matrix for the individual based on contextual factors, the method comprising:
retrieving a wellness score time-series and a plurality of contextual factors time-series, each wellness score time-series and contextual factor time-series being associated with an individual,
wherein the wellness score time-series characterizes the wellness of the associated individual over time, and
wherein each of the contextual factor time-series characterizes one of a plurality of factors of the associated individual over time;
identifying a plurality of influence correlations associated with the individual by, for each influence correlation:
evaluating the wellness score time-series and the plurality of contextual factors time-series for at least one contextual factor correlated with changes in the wellness score of the individual;
determining a weight associated with the correlation between the at least one contextual factor and the wellness score of the individual; and
generating an influence correlation comprised of the at least one contextual factor and the correlation weight;
generating a trigger matrix, associated with the individual, based on the plurality of influence correlations; and
causing a wellness intervention of the individual based on the generated trigger matrix.

2. The method of claim 1, wherein causing a wellness intervention comprises:
retrieving observed contextual factors associated with the individual;
identifying, based on the trigger matrix associated with the individual, whether the observed contextual factors are indicative of a wellness change in the individual;
determining, based on the identified indications of wellness change, whether to cause a wellness intervention for the individual; and
generating, based on the determination, a wellness intervention for the individual.

3. The method of claim 2, wherein the observed contextual factors includes the most recently observed contextual factors for the individual.

4. The method of claim 1, wherein each of the influence correlations is a unique at least one contextual factor.

5. The method of claim 1, wherein the wellness score time-series associated with the individual is generated based on evaluating a plurality of direct factors characterizing the individual at different times.

6. The method of claim 5, wherein the evaluation of the direct factors is done using a wellness assessment model.

7. The method of claim 1, further comprising extending the time-series of contextual factors based on monitoring of the individual.

8. The method of claim 1, wherein generating the trigger matrix comprises:
determining whether the correlation weight of each influence correlation satisfies a threshold weight; and
generating the trigger matrix comprised of the influence correlations with correlation weights satisfying the threshold weight.

9. The method of claim 1, further comprising retrieving a plurality of wellness scores time-series, wherein each wellness score time-series is associated with one of a plurality of wellness aspects, and wherein each influence correlation is further associated with the wellness aspect influenced by the corresponding at least one contextual factor.

10. The method of claim 9, wherein the plurality of wellness aspects comprises overall wellness, dietary wellness, fitness wellness, and mental wellness.

11. A non-transitory computer-readable medium containing instructions configured to cause one or more processors to perform a method for monitoring an individual and generating a trigger matrix for the individual based on contextual factors, the method comprising:
retrieving a wellness score time-series and a plurality of contextual factors time-series, each wellness score time-series and contextual factor time-series being associated with an individual,
wherein the wellness score time-series characterizes the wellness of the associated individual over time, and
wherein each of the contextual factor time-series characterizes one of a plurality of factors of the associated individual over time;
identifying a plurality of influence correlations associated with the individual by, for each influence correlation:
evaluating the wellness score time-series and the plurality of contextual factors time-series for at least one contextual factor correlated with changes in the wellness score of the individual;
determining a weight associated with the correlation between the at least one contextual factor and the wellness score of the individual; and
generating an influence correlation comprised of the at least one contextual factor and the correlation weight;
generating a trigger matrix, associated with the individual, based on the plurality of influence correlations; and
causing a wellness intervention of the individual based on the generated trigger matrix.

12. The non-transitory computer-readable medium of claim 11, wherein causing a wellness intervention comprises:
retrieving observed contextual factors associated with the individual;
identifying, based on the trigger matrix associated with the individual, whether the observed contextual factors are indicative of a wellness change in the individual;
determining, based on the identified indications of wellness change, whether to cause a wellness intervention for the individual; and
generating, based on the determination, a wellness intervention for the individual.

13. The non-transitory computer-readable medium of claim 13, wherein the observed contextual factors includes the most recently observed contextual factors of the individual.

14. The non-transitory computer-readable medium of claim 11, wherein each of the influence correlations is a unique at least one contextual factor.

15. The non-transitory computer-readable medium of claim 11, wherein the wellness score time-series associated with the individual is generated based on evaluating a plurality of direct factors characterizing the individual at different times.

16. The non-transitory computer-readable medium of claim 15, wherein the evaluation of the direct factors is done using a wellness assessment model.

17. The non-transitory computer-readable medium of claim 11, further comprising extending the time-series of contextual factors based on monitoring of the individual.

18. The method of non-transitory computer-readable medium 11, wherein generating the trigger matrix comprises:
determining whether the correlation weight of each influence correlation satisfies a threshold weight; and
generating the trigger matrix comprised of the influence correlations with correlation weights satisfying the threshold weight.

19. The non-transitory computer-readable medium of claim 11, further comprising retrieving a plurality of wellness scores time-series, wherein each wellness score time-series is associated with one of a plurality of wellness aspects, and wherein each influence correlation is further associated with the wellness aspect influenced by the corresponding at least one contextual factor.

20. The non-transitory computer-readable medium of claim 20, wherein the plurality of wellness aspects comprises overall wellness, dietary wellness, fitness wellness, and mental wellness.
